(19) United States
(12) Patent Application Publication
(10) Pub. No.: US 2011/0307610 A1
(43) Pub. Date: Dec. 15, 2011

(54) INFORMATION PROCESSING DEVICE AND INFORMATION PROCESSING PROGRAM

(75) Inventor: Morihiko Hayashi, Kanagawa (JP)

(73) Assignee: SONY CORPORATION, Tokyo (JP)

(21) Appl. No.: 13/152,726

(22) Filed: Jun. 3, 2011

(30) Foreign Application Priority Data
Jun. 11, 2010 (JP) P2010-134178

(51) Int. Cl. G06F 15/173

(52) U.S. Cl. 709/225

(57) ABSTRACT

An information processing device includes a communication section performing communication with other devices on a network, an image generation section generating image information for each of contents stored in another device on the network or in the information processing device itself, with use of address information of the contents, network identification information, and process instruction information provided for each of the contents, the image information representing the three kinds of information, and the network identification information being used for authentication which allows a wireless device to participate in a wireless network configured to include an access point on the network, and a display request section requesting a display device to display, on a screen thereof and together with a content list, the image information generated by the image generation section.

### CROSS-REFERENCE TO RELATED APPLICATION

The present application claims priority from Japanese Patent Application No. JP 2010-134178 filed in the Japanese Patent Office on Jun. 11, 2010, the entire content of which is incorporated herein by reference.

### BACKGROUND

This disclosure relates to an information processing device capable of communicating with devices on a network, and an information processing program which are suitable for such an information processing device.

Recently, with the penetration of digital consumer electronics capable of accessing LAN (local area network), digital contents such as videos, photographs, and music become easily shared through LAN. One of the technical specifications for using devices such as personal computers, consumer electronics, mobile terminals, digital cameras, and mobile phones which are mutually connected and worked together through LAN is DLNA (digital living network alliance) guidelines.

In the DLNA guidelines, with use of UPnP (universal plug and play), it is possible to search a device connected to LAN, or to capture a content list. Further, in the guidelines, contents stored in a certain device on LAN may be reproduced by other devices.

Wireless LAN is also gradually penetrated with the penetration of LAN. Those not familiar with setting of an encrypted communication of wireless LAN is also inevitably increased with penetration of wireless LAN. As a result, for example, while a user is unaware that outside leakage of the electric waves from user's house occurs and others' devices are connectable to the user's wireless LAN, contents owned by the user are at risk of being looked furtively by others. Thus, Wi-Fi Alliance that is an industry group of wireless LAN vender formulates Wi-Fi Protected Setup (WPS) as an implementation specification for setting an encrypted communication of wireless LAN easily. Note that the logo of Wi-Fi is a registered trademark of Wi-Fi Alliance.

Before formulation of WPS, unique specifications for simplifying setting procedures of an encryption key have been implemented in products by many manufacturers, and recently, some methods in which the user does not need to input a password that is for generating an encryption key necessary for an encrypted communication and is called “PIN (personal identification number)” have been widely used. For example, as described on Buffalo's website: http://buffalo.jp/aoss/, a method in which an AOSS (AirStation One-Touch Secure System) (registered trademark of Buffalo Inc.) button of a device to be connected to a wireless LAN is pressed within a predetermined time period after an AOSS button of an access point is pressed, thereby performing authentication has been in practical use as a simple setting method. Moreover, as described on a website of AtermStation: http://121ware.com/product/atermstation/special/rakuraku_start/index.html, a method in which a predetermined button of an access point is pressed to perform authentication has been in practical use as a simple setting method.

However, in the above-described methods, since it is necessary to press a button of an access point, it is extremely inconvenience when a device located away from the access point accesses to a wireless LAN, or when the access point is disposed at a place beyond the reach of a person, for example, under the roof. As described above, the methods in the related art have difficulty that usability of a user is impaired for authentication.

### SUMMARY

It is desirable to provide an information processing device and an information processing program which are capable of performing wireless network connection safely without impairing usability of a user.

A first information processing device according to an embodiment of the technology includes a communication section performing communication with other devices on a network, and an image generation section generating image information representing three kinds of information for each of contents. Specifically, the three kinds of information includes (1) address information of contents held by any of the other devices on the network or by the information processing device, (2) network identification information for authenticating participation of a wireless device to a wireless network configured to include an access point on the network, and (3) process instruction information set for each of the contents. The first information processing device further includes a display request section requesting a display device to display, on a screen thereof and together with a content list, the image information generated by the image generation section.

As used herein, the term “device” refers to a physical or logical entity which is independent and is capable of communicating with other devices in a network environment. The term “content” refers to a bundle of information sensed by a person through viewing, such as news, movies, dramas, television programs, music, images, photographs, videos, games, and animations. The term “authentication” means a process to identify a wireless device in order to allow access to a network.

In the first information processing device according to the embodiment of the technology, the communication section may capture the network identification information from a registrar-function implemented device on the network. Examples of the registrar-function implemented device include an access point. The access point is a device allowing a wireless device to access to a network, and example thereof is a Wi-Fi router. Note that the registrar refers to a logical entity having an authority for issuance and cancellation of the identification information, and the registrar is capable of being integrated into any devices including the access point. In addition, when any of the other devices on the network holds the content, the communication section may capture the address information and the process instruction information from the device. On the other hand, when the first information processing device according to the embodiment of the technology holds the content and the process instruction information in a storage region, the image generation section may read the information from the storage section.

In the first information processing device according to the embodiment of the technology, the network identification information includes, for example, a name of the wireless network and a passcode used for accessing to the wireless network. For example, the passcode is generated by the registrar-function implemented device, and is preferably generated for each of the contents. In addition, in the first information processing device according to the embodiment of the technology, the image information is, for example, a QR code (registered trademark of Denso Wave Inc.).

A first information processing program according to an embodiment of the technology is an information processing program for a device on a network capable of performing communication with other devices on the same network. The first information processing program allows the device to execute the following two steps:

(A1) a step of generating image information for each of contents stored in another device on the network or in the information processing device itself, with use of address information of the contents, network identification information, and process instruction information provided for each of the contents, the image information representing the three kinds of information, and the network identification information being used for authentication which allows a wireless device to participate in a wireless network configured to include an access point on the network; and

(A2) a step of requesting a display device to display, on a screen thereof and together with a content list, the image information generated by the image generation section.

In the first information processing device and the first information processing program according to the embodiments of the technology, the image information representing the network identification information and the like is generated for each of the contents, and the display device is requested to display the generated image information together with the content list on a screen. Therefore, the display device displays the image information representing the network identification information and the like, together with the content list on the screen.

At this time, for example, it is assumed that a user of the first information processing device (hereinafter, simply refer to as a “user”) thinks of copying one content in a content list to a wireless device (for example, personal computers, consumer electronics, mobile terminals, digital cameras, or mobile phones) owned by the user. In this case, the user captures the image information arranged corresponding to the content with use of a camera provided on the wireless device, captures the information represented by the image information, allows the wireless device to output the captured information to the wireless network, thereby capturing the content. At this time, the user recognizes only that the user presses a button of the wireless device several times to capture the image information and capture the desired content. In practice, in the background, as will be described below, a predetermined registration protocol and content transfer are performed between the access point and the wireless device.

For example, first, when information output from the wireless device to the wireless network is received by the access point on the network, the access point performs authentication with use of the network identification information included in the received information. If the authentication is successful, key exchange is performed between the access point and the wireless device, and the setting information such as wireless parameters is transferred from the access point to the wireless device. Next, the wireless device uses the captured setting information such as wireless parameters to access to the wireless network. By performing such a registration protocol, the wireless device becomes possible to perform normal data communication with use of an encryption key common to the access point. After that, the wireless device outputs the address information and the process instruction information which has been captured from the image information to the wireless network. Then, the device corresponding to the address information on the network receives the information from the wireless device to perform processing according to the process instruction information included in the received information. When the process instruction information indicates transfer of a copy of a content corresponding to the address information to the wireless device, the device transfers the copy of the content corresponding to the address information to the wireless device. As a result, the wireless device captures the copy of the content corresponding to the address information. In this way, the content transfer is performed.

A second information processing device according to an embodiment of the technology is an information processing device connecting a wireless device to a network. The second information processing device includes a receiving section receiving a wireless signal including three kinds of information from the wireless device, and a transmitting section transmitting, when any of the other devices on the network requests second network identification information for authenticating participation of the wireless device to the wireless network, the second network identification information to the device which has requested the second network identification information. Specifically, the above-described three kinds of information indicates (1) address information of a first content stored in a first device on the network, (2) first network identification information for authenticating participation of the wireless device to the wireless network of an access point on the network, and (3) process instruction information for the first content. In addition, the second network identification information transmitted by the transmitting section is issued by the transmitting section or is captured from a registrar-function implemented device on the network. The second information processing device according to the embodiment of the technology further includes an authentication section authenticating access of the wireless device, which has transmitted a wireless signal, to the network when the first network identification information is coincident with the second network identification information or when the first network identification information and the second network identification information have a predetermined relationship.

In the second information processing device according to the embodiment of the technology, when the wireless signal including the network identification information and the like is received from the wireless device, whether the first network identification information included in the received information is coincident with the second network identification information transmitted to any of the other devices on the network in past times or whether the first network identification information and the second network identification information have a predetermined relationship is examined. As a result, when the first network identification information is coincident with the second network identification information or when the first network identification information and the second network identification information have a predetermined relationship, the wireless device which has transmitted the wireless signal is allowed to access to the network.

If the authentication is successful as described above, for example, key exchange is performed between the second information processing device and the wireless device, and the setting information such as the wireless parameters is transferred from the second information processing device to the wireless device. Next, the wireless device uses the captured setting information such as wireless parameters to access to the wireless network. By performing such a setting protocol, the wireless device becomes possible to perform normal data communication with use of an encryption key common to the second information processing device. After that, the wireless device outputs, to the wireless network, the address information and the process instruction information which have been captured from the image information. Then, the device corresponding to the address information on the network receives the information from the wireless device through the second information processing device to perform processing according to the process instruction information included in the received information. When the process instruction information indicates transfer of a copy of a content corresponding to the address information to the wireless device, the above-described device transfers the copy of the content corresponding to the address information to the wireless device through the second information processing device. As a result, the wireless device captures the copy of the content corresponding to the address information. In this way, the content transfer is performed.

According to the first information processing device and the first information processing program of the embodiments of the technology, since the image information representing the network identification information and the like is displayed together with the content list on the screen, only a person near the display screen on which the image information is displayed may capture the image information using the wireless device with a camera, access the wireless network using the captured image information, and capture the content. The wireless device is not necessary to be a specific device such as a pre-registered device as long as the device has a camera and a function to access to the wireless network. In addition, in the technology, it is not necessary to press a button of the access point or to perform any setting operation on the access point. Therefore, even if the wireless device is located away from the access point, the wireless device may access to the wireless network, and the access point may be located at a place beyond the reach of a person, for example, under the roof. Accordingly, in the technology, wireless network connection may be performed safely without impairing usability of the user.

According to the second information processing device of the embodiment of the technology, in the case where the wireless signal including the network identification information is received from the wireless device, when it is determined that the first network identification information included in the received information is coincident with the second network identification information transmitted to any of the other devices on the network in past times, or when it is determined that the first network identification information and the second network identification information have a predetermined relationship, the wireless device which has transmitted the wireless signal is allowed to access to the network. Therefore, for example, the image information representing the network identification information and the like is displayed together with the content list on a screen of the device on the network, the image information is captured by the wireless device with a camera which is owned by a person near the display screen where the image information is displayed to access to the wireless network with use of the captured image information, and thus the content is obtainable. Here, the wireless device is not necessary to be a specific device such as a pre-registered device as long as the device has a camera and a function to access to the wireless network. In addition, in the technology, it is not necessary to press a button of the access point or to perform any setting operation on the access point. Therefore, even if the wireless device is located away from the access point, the wireless device may access to the wireless network, and the access point may be located at a place beyond the reach of a person, for example, under the roof. Accordingly, in the technology, wireless network connection is safely achievable without impairing usability of the user.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a diagram illustrating a configuration example of a network system according to an embodiment of the technology.

FIG. 2 is a diagram illustrating a configuration example of a recorder in FIG. 1.

FIG. 3 is a diagram illustrating a configuration example of a digital TV in FIG. 1, which is connected to the recorder.

FIG. 4 is a diagram illustrating a configuration example of a digital TV in FIG. 1, which is directly connected to a wired network.

FIG. 5 is a diagram illustrating a configuration example of an access point in FIG. 1.

FIG. 6 is a diagram illustrating a configuration example of a wireless communication device in FIG. 1.

FIG. 7 is a diagram illustrating an example of display on a screen of the digital TV.

FIG. 8 is a flowchart illustrating an example of procedures of performing registration of the wireless communication device and content transfer to the wireless communication device.

FIG. 9 is a flowchart illustrating another example of procedures of performing registration of the wireless communication device and content transfer to the wireless communication device.

FIG. 10 is a flowchart illustrating an example of a network connection of the wireless communication device.

FIG. 11 is a diagram illustrating another configuration example of the network system in FIG. 1.

### DETAILED DESCRIPTION

Hereinafter, preferred embodiment of the technology will be described in detail with reference to drawings. Incidentally, the description is given in the following order.

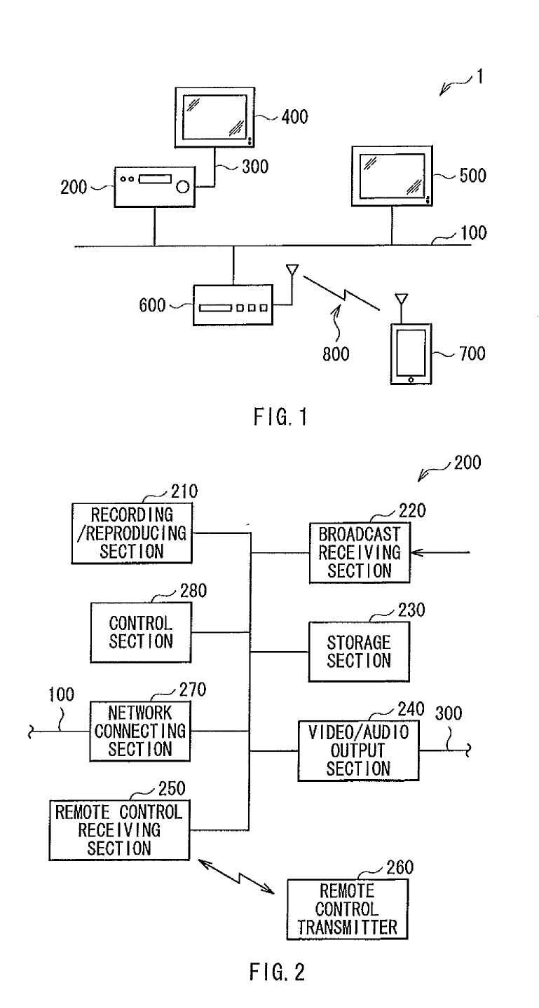

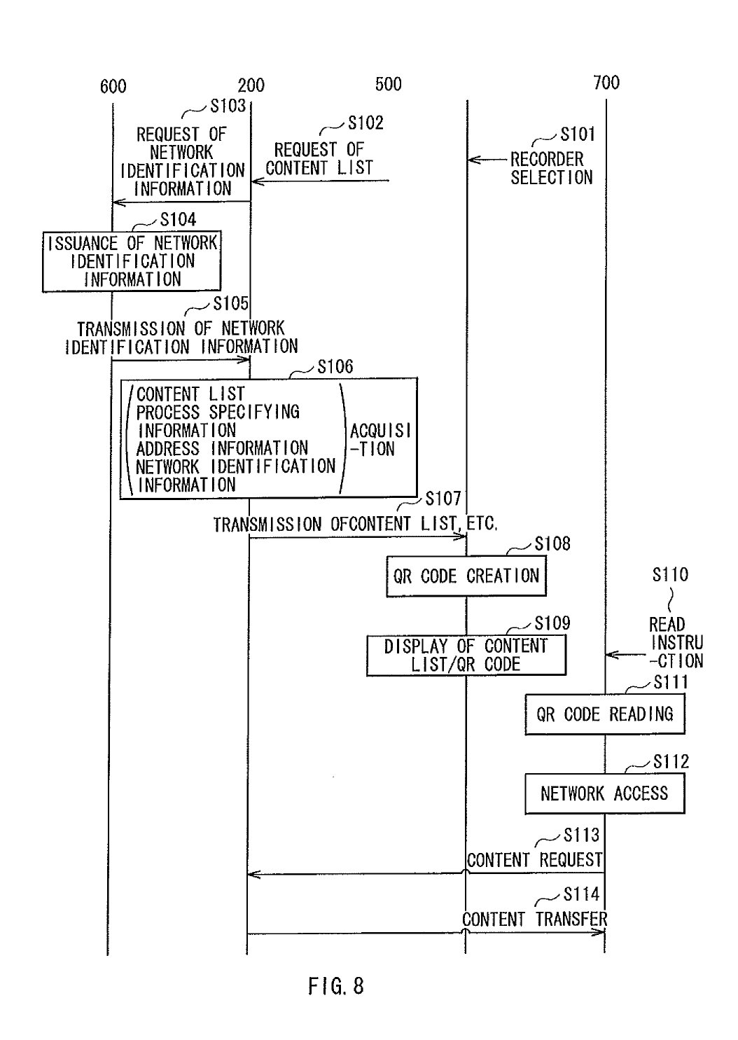

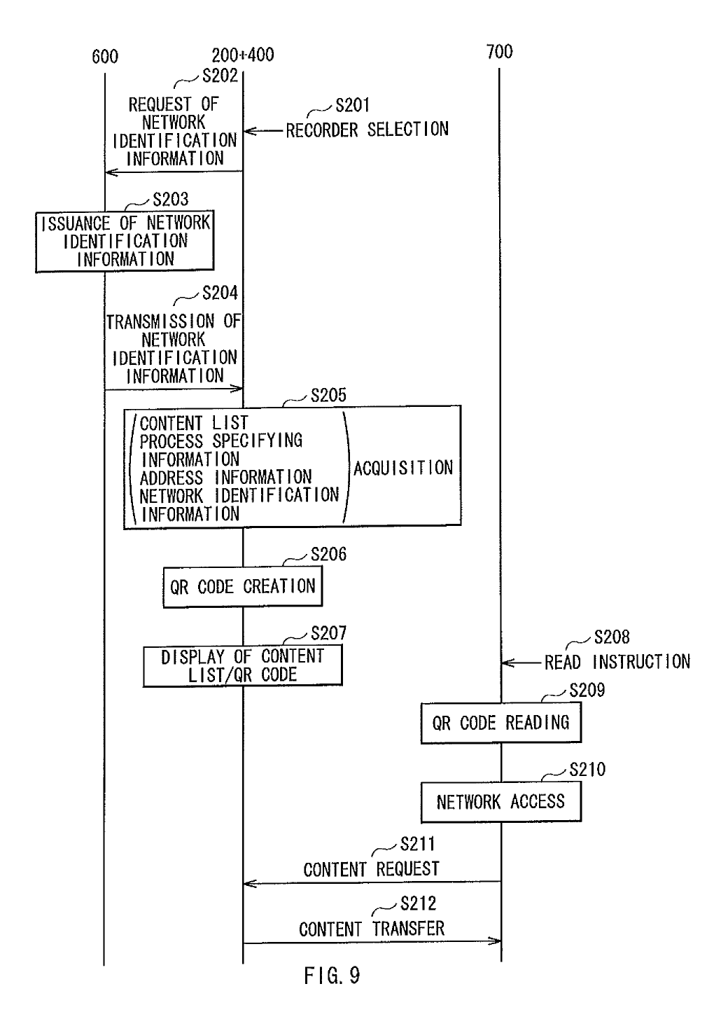

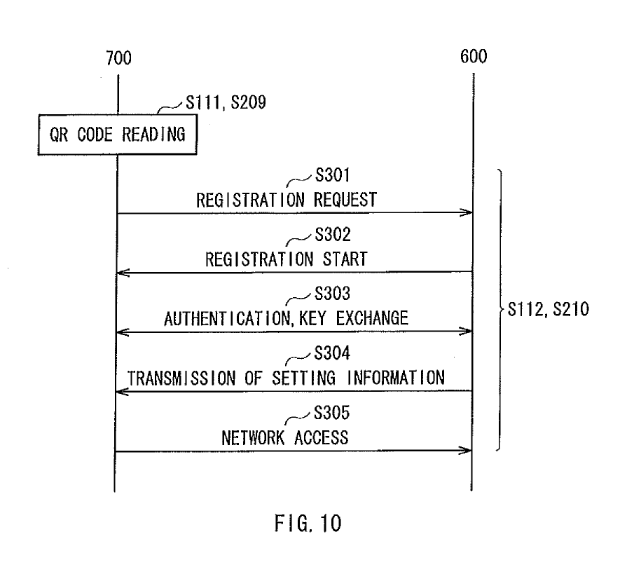

1. Embodiment
System configuration (FIG. 1 to FIG. 7)
Registration/Content transfer (FIG. 8 and FIG. 9)
Network connection (FIG. 10)
Effects

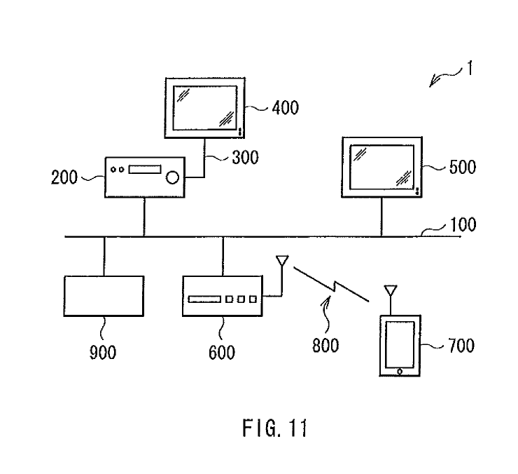

2. Modification (FIG. 11)

### 1. Embodiment

### System Configuration

FIG. 1 is a diagram illustrating a configuration example of a network system 1 according to an embodiment of the technology. The network system 1 includes, for example, a recorder 200, a digital TV 500, and an access point 600 which are connected to a wired network 100. As necessary, CE (consumer electronics) such as digital TVs, personal computers, and mobile information terminals may be connected to the wired network 100. Here, the wired network 100 is, for example, a wired LAN which connects, by using cables, devices to one another in physically adjacent regions. A digital TV 400 is connected to the recorder 200 through an interface cable 300, and a wireless network 800 is constructed in the access point 600. The wireless network 800 is a wireless LAN connecting devices to one another with use of Wi-Fi, for example.

In a region where a communication through the access point 600 and the wireless network 800 is possible (hereinafter, referred to as a “communication-enabled region”), a wireless communication device 700 having a function to access the wireless network 800 is provided. As necessary, other wireless communication devices may be provided in the communication-enabled region. It is assumed that the wireless communication device 700 is not registered to the wireless network 800 and does not access to the wireless network 800 before execution of registration protocol which will be described below.

Note that the wired network 100 corresponds to a specific example of “a network” of the technology. In addition, the recorder 200 and the digital TV 500 correspond to a specific example of “a first information processing device”, and the access point 600 corresponds to a specific example of “a second information processing device” of the technology. The wireless communication device 700 corresponds to a specific example of “a wireless device” of the technology.

### (Recorder 200)

The recorder 200 is a stationary deck capable of reading information from an optical disc such as DVD (digital versatile disc) and BD (Blu-ray Disc), recording information into an optical disc, and further recording information of an optical disc or received television programs into an internal HD (hard disk). As illustrated in FIG. 2, for example, the recorder 200 is provided with a recording/reproducing section 210, a broadcast receiving section 220, a storage section 230, a video/audio output section 240, a remote control receiving section 250, a remote control transmitter 260, a network connecting section 270, and a control section 280. Note that the network connecting section 270 corresponds to a specific example of “a communication section” of the technology, and the control section 280 corresponds to a specific example of “an image generation section” and “a display request section” of the technology.

The recording/reproducing section 210 reads information from an optical disc and is configured to include an optical pickup, for example. The broadcast receiving section 220 receives television broadcast signals to capture video signals and audio signals from the received television broadcast signals, and the broadcast receiving section 220 is configured to include a digital tuner, a demultiplexer, an MPEG decoder, and the like. The storage section 230 stores information read by the recording/reproducing section 210, information received by the broadcast receiving section 220, and the like, and is configured to include HD, flash ROM (read only memory), DRAM (dynamic random access memory) configuring a work area of various software, and the like. The storage section 230 stores, for example, software for controlling an operation of each section of the recorder 200, and for performing predetermined functions. For example, the storage section 230 stores software which captures network identification information in response to request of a content list, and captures other information necessary for generating QR codes to send the captured information back to the device which has requested the content list.

The above-described software is a program executed when “recorder selection”, which will be described later, is performed by a user. Note that the detail of the software will be described later. In addition, the above-described content list is a list of contents stored in the recorder 200. The content list includes, for example, at least a title of each of the contents. The content list may include picture information (thumbnail) related to the respective contents.

The network identification information is for authenticating access of a wireless device (for example, the wireless communication device 700) to the wireless network 800 of the access point 600 on the wired network 100. The network identification information includes, for example, a name of the wireless network 800 (a network name) and a passcode for accessing to the wireless network 800. The network name is a name for identifying a wireless network and, for example, is called SSID (service set identifier) on wireless standards. The passcode is a number of plural digits which is generated at random and necessary for allowing a certain wireless device to access to the wireless network 800. For example, in the case of Wi-Fi Protected Setup program, the passcode is a PIN code of four digits or eight digits.

The video/audio output section 240 transfers, for example, a signal read by the recording/reproducing section 210, a signal generated by the broadcast receiving section 220, a signal read from the storage section 230, or a signal generated by the control section 280 to the digital TV 400 through the interface cable 300 configured of HDMI (high-definition multimedia interface) cable or the like. The video/audio output section 240 also requests the digital TV 400 to display a desired video on a monitor 430 of the digital TV 400. The remote control receiving section 250 receives a remote control signal transmitted from the remote control transmitter 260 through infrared ray to supply the signal to the control section 280.

The network connecting section 270 communicates with other devices through the wired network 100, and is configured to include a network terminal for connecting to the wired network 100, and a network interface. The network interface performs communication with other devices, for example, according to Ethernet (registered trademark) that is one kind of standards of LAN. Ethernet (registered trademark) is a registered trademark of Fuji Xerox Co., Ltd. The control section 280 develops software read from the storage section 230 into the work area of the storage section 230 to activate the software, thereby controlling operations of respective sections of the recorder 200.

### (Digital TV 400)

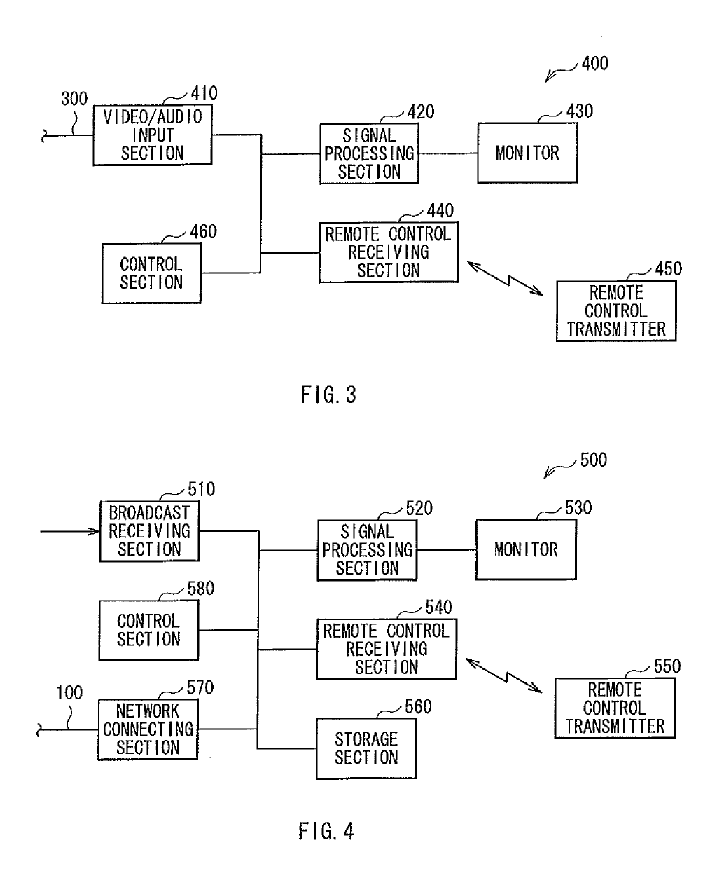

For example, the digital TV 400 is a television not including a broadcast receiving function such as a digital tuner. As illustrated in FIG. 3, for example, the digital TV 400 includes a video/audio input section 410, a signal processing section 420, the monitor 430, a remote control receiving section 440, a remote control transmitter 450, and a control section 460. Incidentally, the digital TV 400 may include a broadcast receiving function such as a digital tuner.

For example, the video/audio input section 410 receives a signal transferred through the interface cable 300 to transfer the signal to the signal processing section 420. The signal processing section 420 performs signal processing such as multi-image processing and superimposing of graphics data as necessary on the transferred video data. Moreover, the signal processing section 420 performs a predetermined signal processing as necessary on the transferred audio signal. Further, the signal processing section 420 outputs the video signal and the audio signal to the monitor 430. The monitor 430 drives a display panel (not illustrated) in the monitor 430 based on the input video signal, and amplifies the input audio signal to drive a speaker (not illustrated) in the monitor 430.

For example, the remote control receiving section 440 receives a remote control signal transferred from the remote control transmitter 450 through infrared ray or the like to supply the signal to the control section 460. The control section 460, for example, develops software read from the storage section (not illustrated) into the work area of the storage section to activate the software, thereby controlling operations of respective sections in the digital TV 400.

### (Digital TV 500)

The digital TV 500 is a television includes a broadcast receiving function such as a digital tuner, and a function to communicate with other devices through the wired network 100. As illustrated in FIG. 4, for example, the digital TV 500 includes a broadcast receiving section 510, a signal processing section 520, a monitor 530, a remote control receiving section 540, a remote control transmitter 550, a storage section 560, a network connecting section 570, and a control section 580. Note that the network connecting section 570 corresponds to a specific example of “a communication section” of the technology, and the control section 580 corresponds to a specific example of “an image generation section” and “a display request section” of the technology.

The broadcast receiving section 510 receives a television broadcast signal to obtain a video signal and an audio signal from the received television broadcast signal, and is configured to include a digital tuner, a demultiplexer, an MPEG decoder, and the like. The broadcast receiving section 510 outputs the captured signals (the video signal and the audio signal) to the signal processing section 520. The signal processing section 520 performs signal processing such as multi-image processing and superimposing of graphics data as necessary on the input video data. Moreover, the signal processing section 520 performs a predetermined signal processing as necessary on the input audio signal. Signals input to the signal processing section 520 may include, for example, a signal generated by the control section 580 in addition to the signal output from the broadcast receiving section 510. Further, the signal processing section 520 outputs the video signal and the audio signal to the monitor 530. The signal processing section 520 also requests the monitor 530 to display a desired video on the monitor 530. The monitor 530 drives a display panel (not illustrated) in the monitor 530 based on the input video signal, and amplifies the input audio signal to drive a speaker (not illustrated) in the monitor 530.

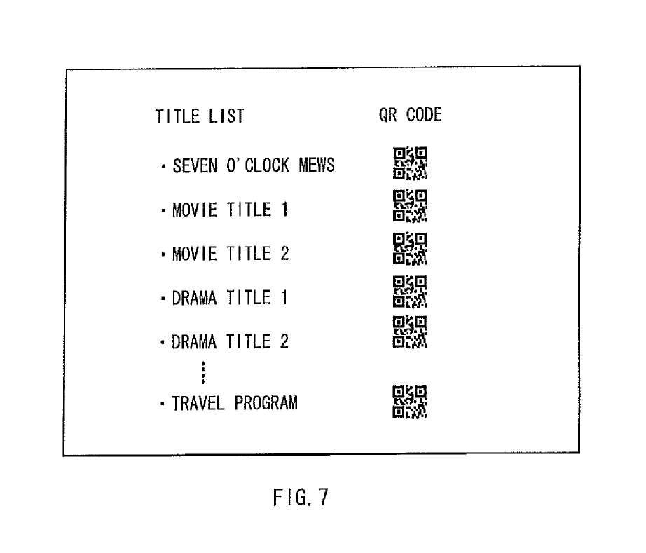

The remote control receiving section 540 receives a remote control signal transmitted from the remote control transmitter 550 through infrared ray or the like to supply the signal to the control section 580. For example, the storage section 560 stores software for controlling operations of respective sections of the digital TV 500 and performing the predetermined functions. For example, the storage section 560 stores software for generating QR code (registered trademark) representing predetermined information, and for displaying the generated QR code together with a content list on a display (the monitor 530) (refer to FIG. 7). The above-described software is a program executed when “recorder selection”, which will be described later, is performed by a user. Note that the detail of the software will be described later.

The network connecting section 570 communicates with other devices through the wired network 100, and is configured to include, for example, a network terminal connecting to the wired network 100, and a network interface. The network interface performs communication with other devices, for example, according to Ethernet (registered trademark) that is one kind of standards of LAN. The control section 580 develops software read from the storage section (not illustrated) into the work area of the storage section to activate the software, thereby controlling operations of respective sections of the digital TV 500.

### (Access Point 600)

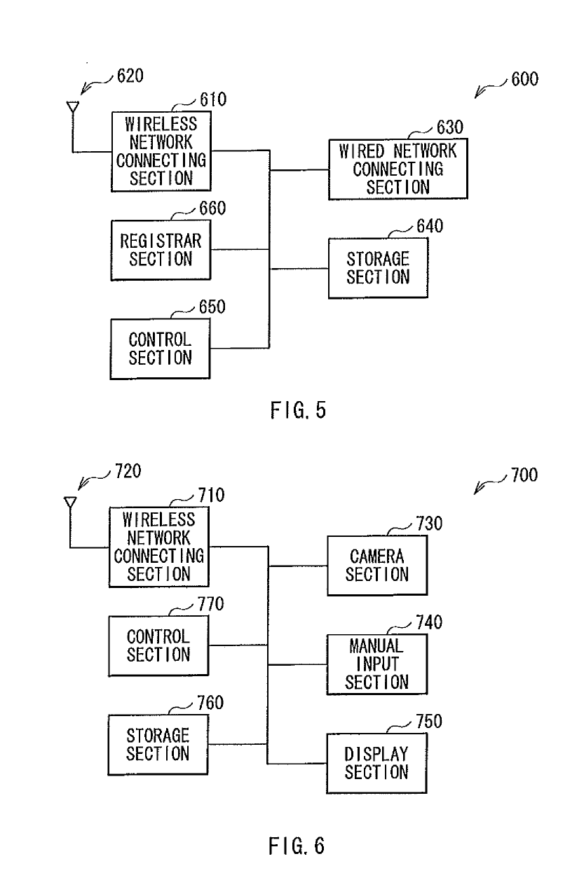

The access point 600 is a device allowing wireless devices such as the wireless communication device 700 to access to a network (the wired network 100), and includes a wireless network connecting section 610, an antenna 620, a wired network connecting section 630, a storage section 640, and a control section 650, for example, as illustrated in FIG. 5.

The wireless network connecting section 610 performs communication with wireless devices such as the wireless communication device 700 through the wireless network 800, and is configured to include, for example, a network terminal for connecting with the wireless network 800, and a network interface. The network interface performs communication with other devices, for example, according to IEEE 802.11 series standards that is one kind of standards of wireless LAN, and is preferably approved as Wi-Fi certificated by Wi-Fi Alliance. The antenna 620 emits electric waves used in communication through the wireless network 800.

The wired network connecting section 630 communicates with other devices through the wired network 100, and is configured to include, for example, a network terminal for connecting with the wired network 100, and a network interface. The network interface performs communication with other devices, for example, according to Ethernet (registered trademark) that is one kind of standards of LAN.

The storage section 640 stores software for controlling operations of respective sections of the access point 600 and for performing predetermined functions. For example, the storage section 640 stores software allowing the access point 600 to execute “registration of wireless devices such as the wireless communication device 700” which will be described later. The above-described software is a program executed when an icon indicating “content acquisition with use of image information (QR code)”, which will be described later, is selected and performed by the wireless communication device 700. Incidentally, the detail of the software will be described later. The control section 650 develops the software read from the storage section 640 into the work area of the storage section 640 to activate the software, thereby controlling operations of respective sections in the access point 600.

The access point 600 further includes a registrar section 660 performing a registrar function. The registrar indicates a logical entity having an authority for issuance and cancellation of network identification information. In the embodiment, the registrar is integrated into the access point 600. Note that the detail of the registrar function will be described later.

### (Wireless Communication Device 700)

The wireless communication device 700 has at least a function to access to the wireless network 800 and a camera function, and is a general-purpose wireless device. Examples of such device include various wireless communication devices such as personal computers, consumer electronics, mobile terminals, digital cameras, and mobile phones. The wireless communication device 700 includes a wireless network connecting section 710, an antenna 720, a camera section 730, a manual input section 740, a display section 750, a storage section 760, and a control section 770, for example, as illustrated in FIG. 6.

The wireless network connecting section 710 performs communication with other devices through the wireless network 800 and the access point 600, and is configured to include a network terminal for connecting to the wireless network 800, and a network interface. The network interface performs communication with other devices, for example, according to IEEE 802.11 series standards that is one kind of standards of wireless LAN, and is preferably approved as Wi-Fi certificated by Wi-Fi Alliance.

The antenna 720 emits electric waves used in communication through the wireless network 800. The camera section 730 is a device for shooting images, and is configured to include a solid-state image sensing device such as a CCD (charge coupled device) image sensor and a CMOS (complementary metal oxide semiconductor) image sensor. The camera section 730 outputs the captured images to the control section 770. The manual input section 740 is for inputting information by, for example, pressing a mechanical button or touching a touch panel by a hand of a user. The manual input section 740 outputs the input information to the control section 770. The display section 750 displays images captured by the camera section 730, the information input by the manual input section 740, and the like.

The storage section 760 stores information received by the wireless network connecting section 710, images captured by the camera section 730, the information input by the manual input section 740, and the like. For example, the storage section 760 is configured to include a HD, a flash ROM, a DRAM configuring a work area of each software. The storage section 760 stores software for controlling operations of respective sections of the wireless communication device 700 and for performing predetermined functions. For example, the storage section 760 stores software for performing wireless network connection easily or for performing acquisition of a desired content easily. The above-described software is a program executed when an icon indicating “content acquisition with use of image information (QR code)”, which will be described later, is selected by a user. Note that the detail of the software will be described later.

### Registration/Content Transfer

Next, described is an example of procedures of registration of the wireless communication device 700 and content transfer to the wireless communication device 700 in the network system 1 of the embodiment. An example of procedures when a program stored in the storage section of each of the recorder 200, the digital TV 500, the access point 600, and the wireless communication device 700 is performed is described below.

FIG. 8 illustrates an example of procedures of performing registration of the wireless communication device 700 and content transfer to the wireless communication device 700. First, a user (not illustrated) is near the digital TV 500 and performs recorder selection with use of the remote control transmitter 550 (Step S101). For example, it is assumed that the user selects the recorder 200. Then, the control section 580 of the digital TV 500 requests a list (content list) of contents stored in the recorder 200 with respect to the recorder 200 (Step S102). When receiving the request of the content list, the control section 280 of the recorder 200 requests network identification information with respect to access point 600 (Step S103). Specifically, the control section 580 of the digital TV 500 requests network identification information of each of the contents stored in the recorder 200 with respect to the access point 600.

The access point 600 has the registrar function to issue network identification information in response to the request from the recorder 200 (Step S104). Specifically, the registrar section 660 of the access point 600 issues network identification information for each of the contents stored in the recorder 200. At this time, the registrar section 660 of the access point 600 relates the issued network identification information to a corresponding content, thereby storing the information in the storage section. After that, the registrar section 660 of the access point 600 sends the issued network identification information back to the recorder 200 (Step S105).

The control section 280 of the recorder 200 captures the network identification information from the access point 600, and captures the list (content list) of the contents stored in the storage section 230 of the recorder 200, process instruction information set for each of the contents, and address information of each of the contents (Step S106).

The process instruction information is information specifying a process for the content. In the case where the content is a moving image, the process instruction information is, for example, a command to specify reproduction of the moving image. The address information is information indicating content location on the wired network 100, and is, for example, a URI (uniform resource identifier).

Next, the control section 280 of the recorder 200 sends the captured content list and the like (the content list, the address information, the network identification information, and the process instruction information) back to the digital TV 500 (Step S107). The control section 580 of the digital TV 500 uses the three kinds of information including the address information, the network identification information, and the process instruction information which are captured from the recorder 200 to create image information representing the three kinds of information for each of the contents. Specifically, the control section 580 of the digital TV 500 uses the above-described three kinds of information to create, as picture information, for example, a QR code for each of the contents (Step S108). The QR code represents information in white and black lattice pattern.

Subsequently, the control section 580 of the digital TV 500 displays the created image information (QR code) together with the content list on a screen (Step S109). Specifically, as illustrated in FIG. 7, for example, the control section 580 of the digital TV 500 generates a picture signal in which the created image information (QR code) is assigned to a corresponding content one by one, and transmits the picture signal to the signal processing section 520, thereby displaying a picture in which QR code is assigned to a corresponding content one by one on the monitor 530.

The user looks for a desired content while viewing the picture displayed on the monitor 530 by performing previous recorder selection. When the user finds the desired content, the user allows the wireless communication device 700 owned by the user to perform read instruction of the image information (QR code) (Step S110). Specifically, the user allows the display section 750 of the wireless communication device 700 to display a menu (not illustrated), and selects an icon (not illustrated) of “content acquisition with use of image information (QR code)” from the menu. Then, the camera section 730 of the wireless communication device 700 is activated to be in a state in which the camera section 730 may capture the image information (QR code). The user holds the camera section 730 of the wireless communication device 700 over the image information (QR code) displayed on the monitor 530 to capture (read) the desired image information (QR code) by the camera section 730 (Step S111). Then, the image information (QR code) captured by the camera section 730 is input to the control section 770 of the wireless communication device 700, and the control section 770 of the wireless communication device 700 performs network connection which will be described later (Step S112).

In such a way, the protocol (registration protocol) of registering the wireless communication device 700 is performed so that the wireless communication device 700 is capable of performing normal data communication with use of an encryption key common to the access point 600.

After that, the control section 770 of the wireless communication device 700 requests the desired content to the recorder 200 (Step S113). Specifically, the control section 770 of the wireless communication device 700 outputs the address information and the process instruction information which have been captured from the image information (QR code) to the wireless network 800. Then, the device (the recorder 200) corresponding to the address information on the wired network 100 receives the information from the wireless communication device 700 to perform processing according to the process instruction information included in the received information. At this time, in the case where the process instruction information indicates the transfer of a copy of the content corresponding to the address information to the wireless communication device 700, the recorder 200 transfers the copy of the content corresponding to the address information to the wireless communication device 700 (Step S114). As a result, the wireless communication device 700 captures the copy of the content corresponding to the address information. In this way, the content transfer is performed.

Note that when the user is near the digital TV 400 connected to the recorder 200 and performs recorder selection with use of the remote control transmitter 450, the procedures including registration of the wireless communication device 700 and content transfer to the wireless communication device 700 are performed as follows, for example.

FIG. 9 illustrates another example of procedures of performing registration of the wireless communication device 700 and content transfer to the wireless communication device 700. First, the user (not illustrated) is near the digital TV 400, and performs recorder selection with use of the remote control transmitter 450 (Step S201). For example, it is assumed that the user selects the recorder 200. The control section 460 of the digital TV 400 notifies the recorder 200 that the user has selected the recorder 200. When receiving the notification, the control section 280 of the recorder 200 requests network identification information with respect to the access point 600 (Step S202). Specifically, the control section 280 of the recorder 200 requests network identification information of each of the contents stored in the recorder 200 with respect to the access point 600. At this time, the network identification information includes a wireless network name and a passcode for accessing the wireless network 800.

Since the access point 600 has a registrar function, the access point 600 issues network identification information in response to the request from the recorder 200 (Step S203). Specifically, the registrar section 660 of the access point 600 issues network identification information for respective contents stored in the recorder 200. At this time, the registrar section 660 of the access point 600 relates the issued network identification information to the corresponding content to store the information in the storage section. After that, the registrar section 660 of the access point 600 sends the issued network identification information back to the recorder 200 (Step S204).

The control section 280 of the recorder 200 captures the network identification information from the access point 600, and captures the list (content list) of contents stored in the storage section 230 of the recorder 200, the process instruction information set for each of the contents, and the address information of each of the contents from the storage section 230 of the recorder 200 (Step S205).

Next, the control section 280 of the recorder 200 uses three kinds of information including the captured address information, the network identification information, and the process instruction information to create image information representing the three kinds of information for each of the contents. Specifically, the control section 280 of the recorder 200 uses the above-described three kinds of information to create, as image information, QR code for each of the contents, for example (Step S206).

Subsequently, the control section 280 of the recorder 200 displays the created image information (QR code) together with the content list on the screen (Step S207). Specifically, as illustrated in FIG. 7, for example, the control section 280 of the recorder 200 generates a picture signal in which the created image information (QR code) is assigned to a corresponding content one by one, and transmits the picture signal to the digital TV 400 to display the picture in which the QR code is assigned to a corresponding content one by one on the monitor 430.

The user looks for a desired content while viewing the picture which is displayed on the monitor 430 by performing the previous recorder selection. When the user finds the desired content, the user allows the wireless communication device 700 owned by the user to perform read instruction of the image information (QR code) (Step S208). Specifically, the user allows the display section 750 of the wireless communication device 700 to display a menu (not illustrated), and selects an icon (not illustrated) indicating “content acquisition with use of image information (QR code)” from the menu. Then, the camera section 730 of the wireless communication device 700 is activated to be in a state where the camera section 730 may capture the image information (QR code). The user holds the camera section 730 of the wireless communication device 700 over the image information (QR code) displayed on the monitor 430 to capture (read) the desired image information (QR code) (Step S209). Then, the image information (QR code) captured by the camera section 730 is input to the control section 770 of the wireless communication device 700, and the control section 770 of the wireless communication device 700 performs the network connection which will be described later (Step S210).

As described above, the protocol (registration protocol) of registering the wireless communication device 700 is performed so that the wireless communication device 700 is capable of performing normal data communication with use of an encryption key common to the access point 600. After that, by performing processes similar to the above-described example, the content transfer to the wireless communication device 700 is performed.

### Network Connection

Next, described is an example of procedures of network connection (the above-described steps S112 and S210) in the network system 1 according to the embodiment. An example of procedures when a program stored in the storage section of each of the access point 600 and the wireless communication device 700 is executed will be described below.

FIG. 10 illustrates an example of procedures of performing network connection (the above-described steps S112 and S210). First, the control section 770 of the wireless communication device 700 transmits a registration request to the access point 600 (Step S301). Specifically, the control section 770 of the wireless communication device 700 transmits, to the access point 600, the three kinds of information (the address information, the network identification information, and the process instruction information) captured by reading the QR code. The control section 650 of the access point 600 transmits a signal indicating registration start in response to three kinds of information input from the wireless communication device 700 (Step S302). Specifically, the control section 650 of the access point 600 transmits, to the wireless communication device 700, a signal including the network identification information corresponding to the address information input from the wireless communication device 700.

Note that in the above-described step, the network identification information input from the wireless communication device 700 to the access point 600 corresponds to a specific example of “first network identification information” of the technology. Moreover, in the above-described step, the network identification information included in the signal which is transmitted to the wireless communication device 700 from the access point 600 as a signal indicating registration start corresponds to a specific example of “second network identification information” of the technology.

Next, the access point 600 and the wireless communication device 700 perform authentication of the identification information mutually (Step S303). Specifically, first, the control section 650 of the access point 600 compares the network identification information input from the wireless communication device 700 to the access point 600 (the first network identification information) with the network identification information corresponding to the address information input from the wireless communication device 700, that is, the network identification information transmitted to other devices (in the above example, the recorder 200) on the wired network 100 in past times (the second network identification information). As a result, the control section 650 of the access point 600 approves success of the authentication when the first network identification information is coincident with the second network identification information or when the first network identification information and the second network identification information have a predetermined relationship. On the other hand, the control section 770 of the wireless communication device 700 compares the network identification information captured by reading the QR code (the first network identification information) with the network identification information included in the signal transmitted to the wireless communication device 700 as a signal indicating registration start (the second network identification information). As a result, the control section 770 of the wireless communication device 700 approves success of the authentication when the first network identification information is coincident with the second network identification information or when the first network identification information and the second network identification information have a predetermined relationship.

In such a way, when both devices approve “success of the authentication”, the key exchange is performed between the access point 600 and the wireless communication device 700 (Step S303). In addition, setting information such as wireless parameters is transferred from the access point 600 to the wireless communication device 700 (Step S304).

As used herein, the wireless parameters is information necessary for access to the wireless network 800, and includes, for example, a network name, a frequency channel, an encryption method, an encryption key, an authentication method, and a passcode. Incidentally, as the wireless parameter transferred from the access point 600 to the wireless communication device 700 in the above-described step, at least an encryption key is used. The encryption key is, for example, a Diffie-Hellman public key.

Finally, the control section 770 of the wireless communication device 700 accesses the wireless network 800 by using the setting information such as the captured wireless parameters (Step S305). By performing such a registration protocol, the wireless communication device 700 may perform normal data communication with use of an encryption key common to the access point 600.

### Effects

In the embodiment, image information (QR code) representing network identification information and the like is displayed together with a content list on a screen. Therefore, only a person near a display screen on which the image information (QR code) is displayed may capture the image information by using the wireless communication device 700 with a camera to access the wireless network 800 with use of the captured image information (QR code), thereby capturing a corresponding content. Here, the wireless communication device 700 is not necessary to be a specific device such as a pre-registered device as long as the device has a camera and a function to access to the wireless network 800. Moreover, in the embodiment, it is not necessary to press a button of the access point 600 or to perform setting operation to the access point 600. Accordingly, even if the wireless communication device 700 is located away from the access point 600, the wireless communication device 700 may access to the wireless network 800, and the access point 600 may be located at a place beyond the reach of a person, for example, under the roof. Therefore, in the embodiment, wireless network connection may be performed safely without impairing usability.

### 2. Modification

As described above, although the technology has been described with the embodiment, the technology is not limited to the embodiment, and various modifications may be made.

For example, in the above-described embodiment, a program used for registration of the wireless communication device 700 and for content transfer to the wireless communication device 700 is stored in the storage section of each of the recorder 200, the digital TV 500, the access point 600, and the wireless communication device 700. However, instead of such a program, a circuit performing registration of the wireless communication device 700 and content transfer to the wireless communication device 700 may be mounted in the recorder 200, the access point 600, and the wireless communication device 700.

In the embodiment, although the access point 600 includes a registrar function, the access point 600 may not include a registrar function. However, in this case, for example, as illustrated in FIG. 11, a registrar 900 formed separately from the access point 600 needs to be connected to the wired network 100. Note that the registrar 900 has a registrar function, and has a function similar to that of the registrar section 660 in the above-described embodiment.

It should be understood by those skilled in the art that various modifications, combinations, sub-combinations and alterations may occur depending on design requirements and other factors insofar as they are within the scope of the appended claims or the equivalent thereof.

What is claimed is:

1. An information processing device comprising:
a communication section performing communication with other devices on a network;
an image generation section generating image information for each of contents stored in another device on the network or in the information processing device itself, with use of address information of the contents, network identification information, and process instruction information provided for each of the contents, the image information representing the three kinds of information, and the network identification information being used for authentication which allows a wireless device to participate in a wireless network configured to include an access point on the network; and
a display request section requesting a display device to display, on a screen thereof and together with a content list, the image information generated by the image generation section.

2. The information processing device according to claim 1, wherein the communication section captures the network identification information from a registrar-function implemented device on the network.

3. The information processing device according to claim 2, wherein
when another device on the network holds the contents, the communication section captures both the address information and the process instruction information from said another device, and
when the information processing device holds both the contents and the process instruction information in a storage region thereof, the image generation section reads the two kinds of information from the storage region.

4. The information processing device according to claim 2, wherein the network identification information includes a name of the wireless network and a passcode used for accessing to the wireless network.

5. The information processing device according to claim 4, wherein the passcode is generated for each of the contents by the registrar-function implemented device.

6. The information processing device according to claim 1, wherein the image information is a QR code.

7. The information processing device according to claim 2, wherein
when another device on the network holds the contents, the communication section captures the content list from said another device, and
when the information processing device holds both the contents and the content list in a storage region thereof, the image generation section reads the content list from the storage region.

8. An information processing device allowing a wireless device to access to a network, the information processing device comprising:
a receiving section receiving, from the wireless device, a wireless signal including address information of contents stored in a first device on the network, first network identification information, and process instruction information provided for the contents, the first network identification information being used for authentication which allows the wireless device to participate in a wireless network at an access point on the network;
a transmitting section, in response to a request from any device on the network, issuing a second network identification information used for authentication which allows the wireless device to participate in the wireless network or capturing the second network identification information from a registrar-function implemented device on the network, and then transmitting the issued or captured second network identification information to the device which has requested the second network identification information; and
an authentication section allowing the wireless device that has transmitted the wireless signal to access to the network, when the first network identification information is coincident with or in a predetermined relationship with the second network identification information.

9. A tangible and computer-readable medium on which an information processing program for a device performing communication with other devices on the same network is non-transitorily recorded, the information processing program comprising:
generating image information for each of contents stored in another device on the network or in the information processing device itself, with use of address information of the contents, network identification information, and process instruction information provided for each of the contents, the image information representing the three kinds of information, and the network identification information being used for authentication which allows a wireless device to participate in a wireless network configured to include an access point on the network; and
requesting a display device to display, on a screen thereof and together with a content list, the image information generated by the image generation section.
